(19) United States
(12) Patent Application Publication
(10) Pub. No.: US 2024/0386622 A1
(43) Pub. Date: Nov. 21, 2024

(54) GENERATIVE ADVERSERIAL NETWORK (GAN) ENABLED VEHICLE WINDSCREEN

(71) Applicant: INTERNATIONAL BUSINESS MACHINES CORPORATION, ARMONK, NY (US)

(72) Inventors: Tushar Agrawal, West Fargo, ND (US); Martin G. Keen, Cary, NC (US); Jeremy R. Fox, Georgetown, TX (US); Sarbajit K. Rakshit, Kolkata (IN)

(21) Appl. No.: 18/319,568

(22) Filed: May 18, 2023

(51) Int. Cl. G06T 11/00; B60K 35/00; G06N 3/0475

(52) U.S. Cl. CPC G06T 11/00; B60K 35/00; G06N 3/0475; B60K 35/60; B60K 35/81; B60K 2360/785; G06V 20/59

(57) ABSTRACT

A method for rendering clear visibility through the windscreen of a vehicle. The method includes monitoring, by one or more sensors, visibility of a windscreen, wherein monitoring includes analyzing a level of visibility of the windscreen, generating a visibility score, and responsive to the visibility score falling below a predetermined threshold, converting, dynamically, the windscreen into a display surface. The method further includes analyzing an external sensor feed of a vehicle to identify the visibility of a surrounding area. The method further includes initiating, dynamically, a generative adversarial network (GAN) enabled adaptation of the surrounding area of the vehicle, in real-time, to reconstruct a visual based on the external sensor feed, and rendering, in real-time, the GAN enabled adaptation of the surrounding area of the vehicle on a transparent display layer of the windscreen of the vehicle.

### BACKGROUND

The present disclosure relates generally to the field of cognitive computing and more particularly to data processing and dynamic rendering of an image on a smart windshield of a vehicle.

Driving automobiles on highways and roadways is a risky and dangerous venture, especially when the windscreen, or windshield, of the automobile is obscured.

The windscreen of an automobile can be obscured, or blurred, due to various reasons such as accumulation of dust, rain, snow, and other natural causes. During those times when a driver cannot see through the windscreen while driving, the driver will either be unable to drive or the driver will drive at a very high risk of getting into an accident due to lack of visibility.

Nowadays, vehicles may contain a transparent display device on the windscreen. The transparent display device is a see-through display that can show digital content. A transparent display is approximately 80% transparent and can be used in various settings. Currently, a transparent display can display depth of field of an object, such as three dimensional (3D) images on the display device.

Currently, there is no ideal way to provide a clear and visible viewpoint through a windscreen of a vehicle, to a driver, in moments of blurred visibility. Therefore, it is necessary to define a new method to solve this problem.

### BRIEF SUMMARY

Embodiments of the present invention disclose a method, a computer program product, and a system.

According to an embodiment, a method, in a data processing system including a processor and a memory, for rendering clear visibility through the windscreen of a vehicle. The method includes monitoring, by one or more sensors, visibility of a windscreen, wherein monitoring includes analyzing a level of visibility of the windscreen, generating a visibility score, and responsive to the visibility score falling below a predetermined threshold, converting, dynamically, the windscreen into a display surface. The method further includes analyzing an external sensor feed of a vehicle to identify the visibility of a surrounding area. The method further includes initiating, dynamically, a generative adversarial network (GAN) enabled adaptation of the surrounding area of the vehicle, in real-time, to reconstruct a visual based on the external sensor feed, and rendering, in real-time, the GAN enabled adaptation of the surrounding area of the vehicle on a transparent display layer of the windscreen of the vehicle.

A computer program product, according to an embodiment of the invention, includes a non-transitory tangible storage device having program code embodied therewith. The program code is executable by a processor of a computer to perform a method. The method includes monitoring, by one or more sensors, visibility of a windscreen, wherein monitoring includes analyzing a level of visibility of the windscreen, generating a visibility score, and responsive to the visibility score falling below a predetermined threshold, converting, dynamically, the windscreen into a display surface. The method further includes analyzing an external sensor feed of a vehicle to identify the visibility of a surrounding area. The method further includes initiating, dynamically, a GAN enabled adaptation of the surrounding area of the vehicle, in real-time, to reconstruct a visual based on the external sensor feed, and rendering, in real-time, the GAN enabled adaptation of the surrounding area of the vehicle on a transparent display layer of the windscreen of the vehicle.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes monitoring, by one or more sensors, visibility of a windscreen, wherein monitoring includes analyzing a level of visibility of the windscreen, generating a visibility score, and responsive to the visibility score falling below a predetermined threshold, converting, dynamically, the windscreen into a display surface. The method further includes analyzing an external sensor feed of a vehicle to identify the visibility of a surrounding area. The method further includes initiating, dynamically, a GAN enabled adaptation of the surrounding area of the vehicle, in real-time, to reconstruct a visual based on the external sensor feed, and rendering, in real-time, the GAN enabled adaptation of the surrounding area of the vehicle on a transparent display layer of the windscreen of the vehicle.

### BRIEF DESCRIPTION OF THE DRAWINGS

FIG. 1 depicts a diagram graphically illustrating the hardware components of computing environment 100 and a cloud computing environment, in accordance with an embodiment of the present invention.

FIG. 2 illustrates GAN enabled windscreen computing environment 200, in accordance with an embodiment of the present invention.

FIG. 3 is a flowchart illustrating the operation of GAN enabled windscreen program 220 of FIG. 2, in accordance with an embodiment of the present invention.

### DETAILED DESCRIPTION

Vehicular accidents are one of the top causes of death in the world. Unfortunately, poor visibility due to weather conditions is a factor for vehicular accidents. Currently, there is no effective solution to eliminate vehicular accidents due to poor visibility through windshields while driving.

Functional vehicular windshield wipers may be effective for clearing vehicular windshields during rain and light snow. However, windshields become blocked or opaque for various reasons, and vehicular windshield wipers may not always be effective in providing clear visibility for the driver. For example, the windshield wipers may be broken, or the blades of the windshield wiper may smudge the windshield instead of clearing the windshield.

For various reasons, the windscreen of a vehicle can be blurred or cannot be viewed through the windscreen, thus making visibility and driving of the vehicle very difficult. For example, visibility is obscured when dust accumulates on the windscreen, or during rainstorms, or accumulation of snow on the windscreen.

Autonomous vehicles have removed many of the responsibilities of a human driver to be in control of the vehicle. However, even though autonomous vehicles can be driven automatically, driving is an experience whereby the driver may also manually drive the autonomous vehicle. As such, the visibility through the vehicle's windscreen is an important factor to consider.

The present invention proposes a method for rendering clear visibility through the windscreen of a vehicle.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

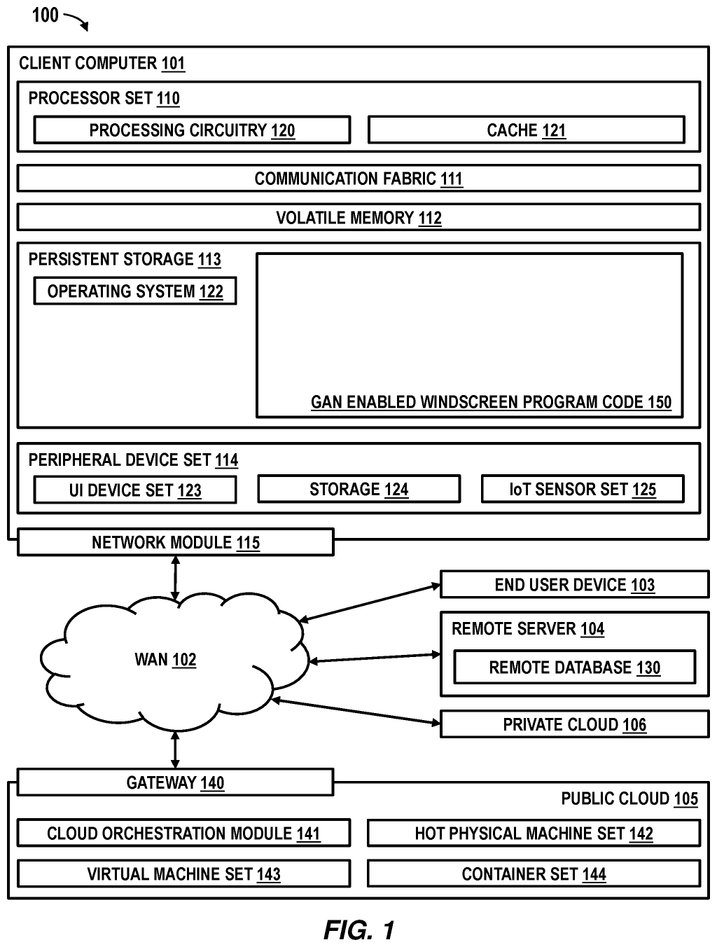

FIG. 1 depicts a diagram graphically illustrating the hardware components of computing environment 100 and a cloud computing environment in accordance with an embodiment of the present invention.

Computing environment 100 contains an example of an environment for the execution of at least some of the computer code involved in performing the inventive methods, such as GAN enabled windscreen program code 150. In addition to the GAN enabled windscreen program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and GAN enabled windscreen program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in GAN enabled windscreen program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface type operating systems that employ a kernel. The code included in proactive driving safety assistance program code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

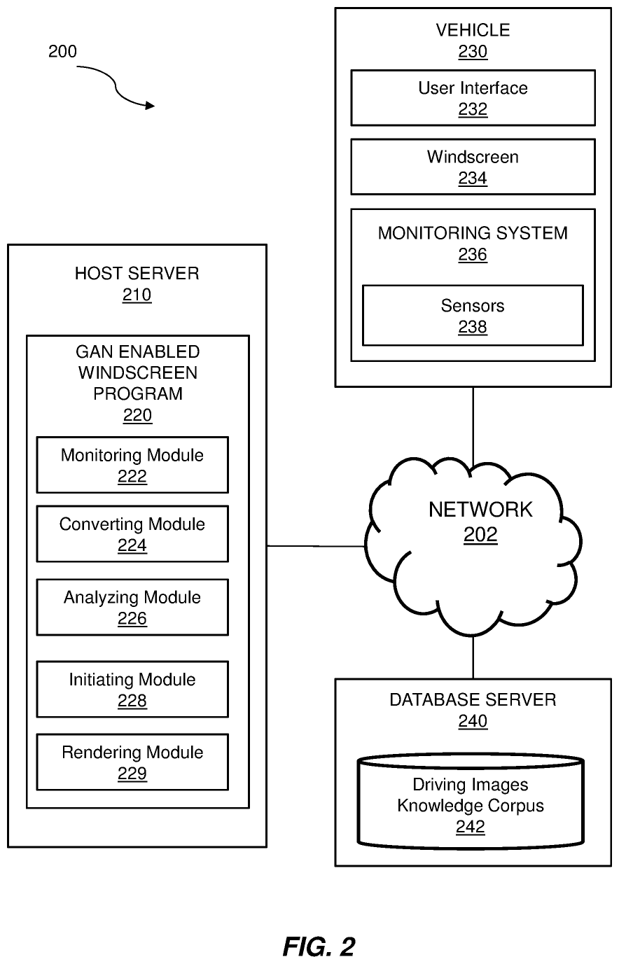

FIG. 2 illustrates GAN enabled windscreen computing environment 200, in accordance with an embodiment of the present invention. GAN enabled windscreen computing environment 200 includes host server 210, vehicle 230, and database server 240, all connected via network 202. The setup in FIG. 2 represents an example embodiment configuration for the present invention and is not limited to the depicted setup to derive benefit from the present invention.

In an exemplary embodiment, host server 210 includes GAN enabled windscreen program 220. In various embodiments, host server 210 may be a laptop computer, tablet computer, netbook computer, personal computer (PC), a desktop computer, a personal digital assistant (PDA), a smart phone, or any programmable electronic device capable of communicating with vehicle 230, and database server 240, via network 202. Host server 210 may include internal and external hardware components, as depicted, and described in further detail with reference to FIG. 1. In other embodiments, host server 210 may be implemented in a cloud computing environment, as further described in relation to FIG. 1 herein. Host server 210 may also have wireless connectivity capabilities allowing it to communicate with vehicle 230, and database server 240, and other computers or servers over network 202.

With continued reference to FIG. 2, vehicle 230 includes user interface 232, windscreen 234, and monitoring system 236. In exemplary embodiments, vehicle 230 may be a car, a minivan, a truck, a tractor-trailer, a train, or any road (or off-road) vehicle. In exemplary embodiments, vehicle 230 can detect outside road conditions and current visibility conditions through windscreen 234 of vehicle 230, via monitoring system 236.

In alternative embodiments, vehicle 230 may be any type of vehicle, such as a vehicle that flies in the sky (e.g., airplane, rocket ship, hot-air balloon, hovercraft, etc.), a vehicle that floats on the water (e.g., motorboat, yacht, jet ski, pontoon, freight ship, etc.), and any other vehicle, known to one of ordinary skill in the art, capable of being operated by a human.

While the present application focuses primarily on a GAN enabled windscreen via an automobile, the scope of the invention is not limited to vehicles. For example, the present invention may be used for any electronic device, gadget, machinery, hydraulics, or defined space that is operated by a human, containing a monitoring system where avoidance of dangerous conditions, via visibility through a windscreen, may be monitored and evaluated.

In exemplary embodiments, vehicle 230 includes user interface 232, which may be a computer program that allows a user to interact with vehicle 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210.

In exemplary embodiments, user interface 232 may be a touch screen display, a visual display, a remote operated display, or a display that receives input from a physical keyboard or touchpad located within vehicle 230, such as on the dashboard, console, etc. In alternative embodiments, user interface 232 may be operated via voice commands, BLUETOOTH, a mobile device that connects to vehicle 230, or by any other means known to one of ordinary skill in the art. In exemplary embodiments, a user may interact with user interface 232 to report a problem, update data inputs and/or visibility of conditions of windscreen 234, and/or update user preferences. In various embodiments, a user may interact with user interface 232 to provide feedback to GAN enabled windscreen program 220 via network 202.

In exemplary embodiments, vehicle 230 includes windscreen 234, which includes a windscreen glass together with a flexible transparent display layer attached to the inner surface of the windscreen glass. The flexible transparent display layer attached to the windscreen glass can project an image onto its surface.

In exemplary embodiments, the flexible transparent display layer attached to the windscreen 234 can display a GAN adapted visual surrounding (e.g., the reconstructed surrounding scene of the vehicle 230 to the driver).

In exemplary embodiments, vehicle 230 includes monitoring system 236, which comprises sensors 238. Sensors 238 may be a device, hardware component, module, or subsystem capable of detecting events or changes in a user environment and sending the detected data to other electronics (e.g., host server 210), components (e.g., driving images knowledge corpus 242), or programs (e.g., GAN enabled windscreen program 220) within a system such as GAN enabled windscreen computing environment 200. In exemplary embodiments, sensors 238 are located outside of vehicle 230 and inside of vehicle 230. The detected data collected by sensors 238 may be instrumental in determining whether vehicle 230, together with the driver, are in danger due to a road condition/obstruction/occurrence.

Sensors 238, in exemplary embodiments, may be a global positioning system (GPS), software application, proximity sensor, camera, dashboard camera, microphone, light sensor, infrared sensor, ultrasonic sensor, weight sensor, temperature sensor, tactile sensor, motion detector, optical character recognition (OCR) sensor, occupancy sensor, heat sensor, analog sensor (e.g., potentiometers, force-sensing resistors), radar sensors, lidar sensors, radio frequency sensor, video camera, digital camera, Internet of Things (IoT) sensors, lasers, gyroscopes, accelerometers, structured light systems, and other devices used for measuring an environment and/or visibility in front of windscreen 234.

In alternative embodiments, GAN enabled windscreen computing environment 200 may include any other systems and methods for collecting and utilizing vehicle 230 data, driving status data, and windscreen visibility data within an IoT system, known to one of ordinary skill in the art.

In exemplary embodiments, monitoring system 236 is capable of continuously monitoring, collecting, and saving collected data on database server 240, a local storage database, or sending the collected data to GAN enabled windscreen program 220 for analysis and storage. In alternative embodiments, monitoring system 236 may be capable of detecting, communicating, pairing, or syncing with IoT devices, thus creating opportunities for more direct integration of the physical world into computer-based systems, and resulting in improved efficiency, accuracy, and economic benefit in addition to reduced human intervention.

Monitoring system 236 may be capable of transmitting detected and monitored visibility data to GAN enabled windscreen program 220, either on a continuous basis or at set intervals. In other embodiments, monitoring system 236 may be configured to detect and monitor a windscreen's visibility based on any method known to one of ordinary skill in the art.

In various embodiments, sensors 238 may be embedded within vehicle 230 and contain a computer processing unit (CPU), memory, and power resource, and may be capable of communicating with vehicle 230, database server 240, and host server 210 over network 202.

In exemplary embodiments, database server 240 includes driving images knowledge corpus 242. In various embodiments, database server 240 may be a laptop computer, tablet computer, netbook computer, personal computer (PC), a desktop computer, a personal digital assistant (PDA), a smart phone, a server, or any programmable electronic device capable of communicating with host server 210 and vehicle 230, via network 202. Database server 240 may include internal and external hardware components, as depicted, and described in further detail with reference to FIG. 1. In other embodiments, database server 240 may be implemented in a cloud computing environment, as described in relation to FIG. 1. Database server 240 may also have wireless connectivity capabilities allowing it to communicate with host server 210, vehicle 230, and other computers or servers over network 202.

In further exemplary embodiments, driving images knowledge corpus 242 may store the multiple video frames captured by a camera inside vehicle 230, looking out through windscreen 234, that assesses the visibility from the driver's position inside the vehicle 230 looking out.

In exemplary embodiments, various image processing methods may be used to generate visibility scores, such as convolutional neural network (CNN), Gabor filter based features, local binary patterns (LBP) histogram, and scale invariant feature transform (SIFT) points.

In exemplary embodiments, driving images knowledge corpus 242 may store time series live images of the surrounding environment through the windscreen 234 according to weather conditions, driver, visibility score, and any other type of category known to one of ordinary skill in the art.

While driving images knowledge corpus 242 is depicted as being stored on database server 240, in other embodiments, driving images knowledge corpus 242 may be stored on vehicle 230, host server 210, GAN enabled windscreen program 220, or any other device or database connected via network 202, as a separate database. In alternative embodiments, driving images knowledge corpus 242 may be comprised of a cluster or plurality of computing devices, working together, or working separately.

With continued reference to FIG. 2, host server 210 includes GAN enabled windscreen program 220. Host server 210 may be a laptop computer, tablet computer, netbook computer, personal computer (PC), a desktop computer, a personal digital assistant (PDA), a smart phone, or any programmable electronic device capable of communicating with vehicle 230, and database server 240 via network 202.

With continued reference to FIG. 2, GAN enabled windscreen program 220, in an exemplary embodiment, may be a computer application on host server 210 that contains instruction sets, executable by a processor. The instruction sets may be described using a set of functional modules. In exemplary embodiments, GAN enabled windscreen program 220 may receive input from vehicle 230 and database server 240 over network 202. In alternative embodiments, GAN enabled windscreen program 220 may be a computer application on vehicle 230, or a standalone program on a separate electronic device.

With continued reference to FIG. 2, the functional modules of GAN enabled windscreen program 220 include monitoring module 222, converting module 224, analyzing module 226, initiating module 228, and rendering module 229.

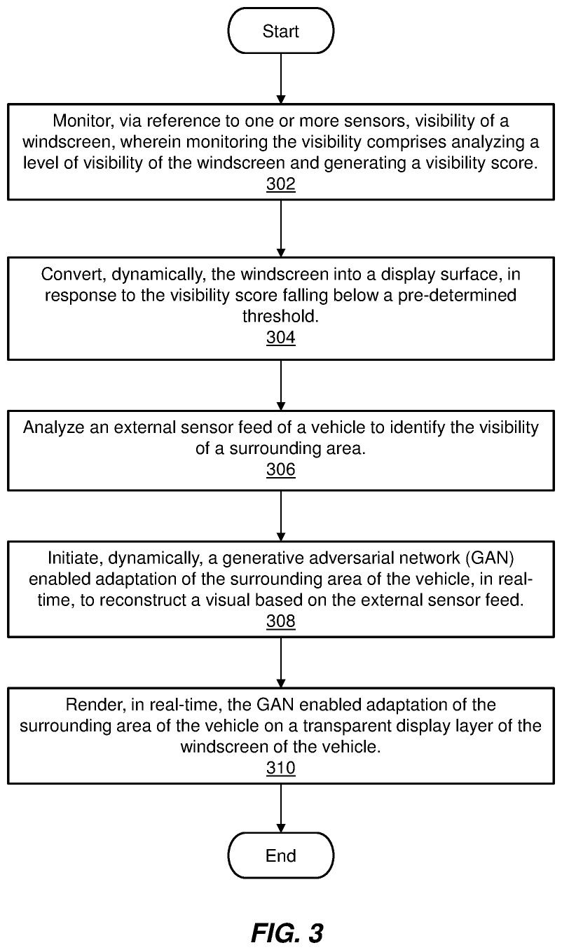

FIG. 3 is a flowchart illustrating the operation of GAN enabled windscreen program 220 of FIG. 2, in accordance with embodiments of the present disclosure.

With reference to FIGS. 2 and 3, monitoring module 222 includes a set of programming instructions, in GAN enabled windscreen program 220, to monitor, by one or more sensors, visibility of a windscreen, wherein monitoring the visibility comprises analyzing a level of visibility of the windscreen and generating a visibility score (step 302). The set of programming instructions is executable by a processor.

In exemplary embodiments, monitoring system 222 helps to gather information from sensors 238 located inside and outside vehicle 230. From the gathered sensor information, monitoring module 222 then analyzes a level of visibility and decides whether to activate GAN to reconstruct the surrounding scene.

While vehicle 230 is being driven, the driver can see the surrounding area through the transparent display attached to the windscreen 234, so long as the windscreen 234 is not obscured with rain, snow, sleet, and any other natural element or substance.

In exemplary embodiments, two cameras (e.g., sensors 238) are placed within vehicle 230; one at the front side inside vehicle 230 and another placed at the front side outside vehicle 230. The cameras are used to monitor, or capture images, of the surrounding scene and these images are then sent to a processing unit in GAN enabled windscreen program 220.

In exemplary embodiments, monitoring module 222 can communicate with other sensors 238 (e.g., cameras) fitted into vehicle 230, such as side repeater cameras.

In further exemplary embodiments, monitoring module 222 can interface with other sensors 238, either located within vehicle 230 or located on other nearby vehicles, such as radar sensors, lidar sensors, ultrasonic sensors, infrared sensors, and any other sensor known to one of ordinary skill in the art. In this fashion, monitoring module 222 analyzes a level of visibility through windscreen 234, as well as captured images of the surrounding scene directly in front of vehicle 230.

In exemplary embodiments, there is a camera inside vehicle 230, towards the windscreen 234, which can identify the quality of visibility of the surrounding area through windscreen 234. This way, monitoring module 222 assesses the visibility from the driver's position inside the vehicle 230 looking out.

Monitoring module 222 generates a visibility score based upon video, and image, frames captured by the camera inside vehicle 230. In exemplary embodiments, various image processing methods can be used to generate the visibility score.

Such image processing methods may include a convolutional neural network (CNN). A CNN provides object identification, for example the appearance of other vehicles, the roadway, road signs, and so forth.

Another image processing method may include Gabor filter-based features. This method can be used to identify drivable areas. Drivable areas are areas where all four tire tracks can be seen in an upcoming lane on the roadway. The feature vectors are generated by extracting Gabor filters via a scale space representation, which are represented as Gabor feature forward layer.

In alternative embodiments, another image processing method includes local binary patterns (LBP) histogram, which are useful in identifying the drivable areas since it contains binary information about which pixels are on a roadway.

Another image processing method may include scale invariant feature transform (SIFT) points. SIFT points are used to detect the drivable area edges and they have been shown to be effective in detecting objects from aerial images.

In exemplary embodiments, the visibility score is the sum of the four aforementioned scores (CNN, Gabor filter, LBP histogram, and SIFT points), providing a value in [−1, 1] format where −1 indicates a complete visual blockage and +1 indicates complete clear vision through windscreen 234. The total visibility function is calculated as the weighted average of CNN, Gabor filter-based features, and LBP histogram.

In exemplary embodiments, the visibility score is calculated over a time series of captured video/images. This generates patterns of visibility such as when visibility is becoming progressively better or progressively worse. Time series analysis techniques include autocorrection, sliding window correlation, and spectral analysis.

If the visibility score is beyond a pre-defined threshold and continues to stay below this threshold, or worsen over a time series, then the invention proceeds to the next stage: GAN enabled windscreen 234 adaptation.

With reference to an illustrative example, Joe is driving to work along a busy interstate highway. Suddenly, a storm front happens upon Joe. Joe turns on his windshield wipers, but the rain is coming down so hard and fast that the windshield wipers are not having any effect on making Joe's visibility on the road any clearer. And now, Joe's windshield is fogging up, making visibility even worse. Joe is very concerned about getting into a car accident and wishes he was able to clearly see the roadway, and other drivers, in front of him. Luckily, Joe has GAN enabled windscreen program 220 installed in his car. Monitoring module 222, via sensors 238, analyzes the current state of visibility through windscreen 234 and generates a visibility score of −1, meaning a complete visual blockage.

With continued reference to FIGS. 2 and 3, converting module 224 includes a set of programming instructions in GAN enabled windscreen program 220, to convert, dynamically, the windscreen into a display surface, in response to the visibility score falling below a predetermined threshold (step 304). The set of programming instructions is executable by a processor.

In exemplary embodiments, if the visibility score meets or exceeds a pre-defined threshold, then no action is taken and the driver will continue to see through the transparent display on windscreen 234 as normal. If, however, the visibility score falls below the pre-defined threshold, then the GAN enabled adaptation process is initiated.

With continued reference to FIGS. 2 and 3, analyzing module 226 includes a set of programming instructions in GAN enabled windscreen program 220, to analyze an external sensor feed of a vehicle to identify the visibility of a surrounding area (step 306). The set of programming instructions is executable by a processor.

In exemplary embodiments, analyzing module 226 analyzes the visibility of a surrounding area (i.e., darkness, snowing, raining, fog, etc.) and accordingly the system dynamically enables GAN to reconstruct the surrounding scene to be shown on the transparent display layer of the windscreen 234.

In exemplary embodiments, analyzing module 226 is capable of adaptive field of view augmentation. Analyzing module 226 identifies a driver's viewing direction and, accordingly, aligns the external camera (sensor) feed of the vehicle 230 with the real-time rendering of the GAN enabled adaptation of the surrounding area on the transparent display layer of the windscreen 234.

In other words, the external camera feed of vehicle 230 are auto adapted with GAN and the camera feeds are aligned with the viewing direction of the driver (as camera position, field of view, and driver's viewing direction and position will not be the same, so GAN adapts to the driver's viewing direction). For example, analyzing module 226 may alert the driver that he/she is looking left, and a vehicle is approaching at high speed from the right and will cause an accident if the driver does not react.

In alternative embodiments, analyzing module 226 is capable of selective augmentation positioning. Based on available processing capability to perform real-time GAN based image adaptation on the transparent display layer of the windscreen 234, available battery power, and the surrounding context, the proposed system will be identifying how much surrounding view is sufficient for a driver to drive the vehicle 230. Accordingly, GAN enabled windscreen program 220 will use GAN to selectively adapt the surrounding view through windscreen 234.

In exemplary embodiments, analyzing module 226 identifies a minimum amount of GAN enabled adaptation of the surrounding area data to render, on the transparent display layer of the windscreen 234, enough of the surrounding area that is adequate to remove an identified visibility issue.

In alternative embodiments, identifying a minimum amount of GAN enabled adaptation of the surrounding area data to render, on the transparent display layer of the windscreen 234, enough of the surrounding area that is adequate to remove an identified visibility issue is based on data collected from one or more vehicles in a multi-vehicle ecosystem, and wherein the one or more vehicles collaborate with each other based on a relative position and direction of the one or more vehicles in the multi-vehicle ecosystem.

In alternative embodiments, wherein initiating the GAN enabled adaptation of the surrounding area of the vehicle, further includes setting a maximum velocity limit of the vehicle to execute the GAN enabled adaptation to restore visibility to the user.

With continued reference to the illustrative example above, Joe's vehicle analyzes the roadway in front of him, via sensors 238, and generates a time series of live images of the surrounding scene. GAN enabled windscreen program 220 determines that the windscreen of Joe's vehicle must be converted to a display surface depicting the surrounding roadway in real-time, based on Joe's poor visibility score.

With continued reference to FIGS. 2 and 3, initiating module 228 includes a set of programming instructions in GAN enabled windscreen program 220, to initiate, dynamically, a generative adversarial network (GAN) enabled adaptation of the surrounding area of the vehicle, in real-time, to reconstruct a visual based on the external sensor feed (step 308). The set of programming instructions is executable by a processor.

In exemplary embodiments, if the visibility score meets or exceeds the pre-defined threshold, then no action is taken. The driver will continue to see through the transparent display layer of the windscreen 234 as normal. If, however, the visibility score falls below the pre-defined threshold, then the GAN enabled adaptation process is initiated by initiating module 228.

In exemplary embodiments, initiating module 228 generates a new synthetic image that approximates the surrounding scene in front of, and near, vehicle 230. The new synthetic image is generated using the camera feeds, lidar, radar, and other available sensors 238 that go beyond the driver's view through windshield 234.

In further exemplary embodiments, the newly generated synthetic images of the surrounding scene are now capable of being displayed on the dynamically converted windscreen 234 containing the transparent flexible display, so that the driver can view the surrounding scene while driving the vehicle 230.

In exemplary embodiments, initiating module 228 compares the original images with a series of new synthetic images via a GAN discriminator to determine how similar they are.

In exemplary embodiments, initiating module 228 determines a similarity threshold of the compared original images with the series of new synthetic images, scores the series of new synthetic images as highly representative if determined to be above a pre-defined threshold, and processes the GAN enabled adaptation on the transparent display layer of the windscreen 234.

If the difference between the two images is below a pre-defined threshold, then no action is taken, and the driver will continue to see through the transparent display on windscreen 234 as normal. However, if initiating module 228 scores the synthetic image as highly representative, then the synthetic image is scored accordingly.

In further exemplary embodiments, GAN enabled windscreen program 220 continues to create and score synthetic images. When GAN enabled windscreen program 220 generates images that are continually scored beyond a defined threshold, then the invention moves to render the synthetic images on the transparent display layer of the windscreen 234.

With continued reference to the illustrative example above, the GAN enabled windscreen program 220 initiates an adaptation of the roadway in front of Joe's car, based on Joe's viewing direction. Initiating module 228 identifies what degree of GAN based adaptation is required for Joe to continue driving safely along the roadway, and further compares the images of Joe's viewpoint through his visibly blocked windscreen 234 with the images of the roadway and surrounding scene in front of Joe's car. The GAN enabled system performs real-time updates of the visual surrounding area outside of Joe's car.

With continued reference to FIGS. 2 and 3, rendering module 229 includes a set of programming instructions in GAN enabled windscreen program 220, to render, in real-time, the GAN enabled adaptation of the surrounding area of the vehicle on a transparent display layer of the windscreen of the vehicle (step 310). The set of programming instructions is executable by a processor.

In exemplary embodiments, rendering module 229 updates, continually, the series of new synthetic images at a highest frame rate supported by the GAN enabled adaptation and projects the series of new synthetic images onto the transparent display layer of the windscreen 234.

In exemplary embodiments, various methods may be used to support a high frame rate. One method to support a high frame rate is temporarily increasing capture rate of sensors 238. Increasing the frame rate of the external cameras, cycles of the lidar sensors and radar sensors. Another method to support a high frame rate is partial image generation. Partial image generation generates only partial views and ignores sections of the windshield outside of the driver's primary field of view, which reduces computation complexity. A third method to support a high frame rate is multi-resolution rendering. Multi-resolution rendering renders critical images, such as the brake lights of the vehicles in front in high detail, and rendering supplemental details such as trees and countryside at a lower resolution.

In alternative embodiments, rendering module 229 can control the maximum velocity of the vehicle 230 to correspond with the refresh rate of the GAN generated images. In this way, a vehicle 230 can be artificially slowed when GAN refresh rates are operating at a lower frame rate.

In alternative embodiments, the transparent display layer of the windscreen 234 ceases to render GAN imagery when either the native visibility through the windscreen 234 returns above a threshold level or the GAN generation is no longer satisfying the GAN discriminator component to create sufficiently representative images.

In preferred embodiments, the proposed invention uses a camera placed inside the vehicle 230 to analyze the level of clarity to view the surrounding area through windscreen 234, and based on a threshold level, the proposed invention converts the windscreen 234 to a display surface. The system further leverages GAN to reconstruct the surrounding area based on the driver's field of view and renders the reconstructed surrounding area on the transparent display layer on the windscreen 234 so that the driver can see the surrounding area in real-time.

With continued reference to the illustrative example above, rendering module 229 projects the real-time images from outside Joe's car (e.g., cars in front of him, obstacles on the roadway, etc.) onto the transparent display layer of Joe's windshield, so that he can continue to drive on the roadway in a safe manner.

In exemplary embodiments, network 202 is a communication channel capable of transferring data between connected devices and may be a telecommunications network used to facilitate telephone calls between two or more parties comprising a landline network, a wireless network, a closed network, a satellite network, or any combination thereof. In another embodiment, network 202 may be the Internet, representing a worldwide collection of networks and gateways to support communications between devices connected to the Internet. In this other embodiment, network 202 may include, for example, wired, wireless, or fiber optic connections which may be implemented as an intranet network, a local area network (LAN), a wide area network (WAN), or any combination thereof. In further embodiments, network 202 may be a Bluetooth network, a WiFi network, or a combination thereof. In general, network 202 can be any combination of connections and protocols that will support communications between host server 210, vehicle 230, and database server 240.

1. A computer-implemented method comprising:
monitoring, via reference to one or more sensors, visibility of a windscreen, wherein monitoring the visibility comprises:
analyzing a level of visibility of the windscreen; and
generating a visibility score;
converting, dynamically, the windscreen into a display surface, in response to the visibility score falling below a predetermined threshold;
analyzing an external sensor feed of a vehicle to identify the visibility of a surrounding area;
initiating, dynamically, a generative adversarial network (GAN) enabled adaptation of the surrounding area of the vehicle, in real-time, to reconstruct a visual based on the external sensor feed; and
rendering, in real-time, the GAN enabled adaptation of the surrounding area of the vehicle on a transparent display layer of the windscreen of the vehicle.

2. The computer-implemented method of claim 1, further comprising:
aligning the external sensor feed, of an identified viewing direction of a user, with the real-time rendering of the GAN enabled adaptation of the surrounding area on the transparent display layer of the windscreen.

3. The computer-implemented method of claim 1, further comprising:
identifying a minimum amount of GAN enabled adaptation of the surrounding area data to render, on the transparent display layer of the windscreen, that is adequate to remove an identified visibility issue.

4. The computer-implemented method of claim 3, wherein identifying a minimum amount of GAN enabled adaptation of the surrounding area data to render, on the transparent display layer of the windscreen, that is adequate to remove an identified visibility issue is based on:
data collected from one or more vehicles in a multi-vehicle ecosystem, and wherein the one or more vehicles collaborate with each other based on a relative position and direction of the one or more vehicles in the multi-vehicle ecosystem.

5. The computer-implemented method of claim 1, wherein initiating the GAN enabled adaptation of the surrounding area of the vehicle, further comprises:
setting a maximum velocity limit of the vehicle to execute the GAN enabled adaptation to restore visibility to the user.

6. The computer-implemented method of claim 1, further comprising:
comparing original images with a series of new synthetic images via a GAN discriminator;
determining a similarity threshold of the compared original images with the series of new synthetic images;
scoring the series of new synthetic images as highly representative if determined to be above a pre-defined threshold; and
processing the GAN enabled adaptation on the transparent display layer of the windshield.

7. The computer-implemented method of claim 6, further comprising:
updating, continually, the series of new synthetic images at a highest frame rate supported by the GAN enabled adaptation;
projecting the series of new synthetic images onto the transparent display layer of the windshield.

8. A computer program product, comprising a tangible storage device having program code embodied therewith, the program code executable by a processor of a computer to perform a method, the method comprising:
monitoring, via reference to one or more sensors, visibility of a windscreen, wherein monitoring the visibility comprises:
analyzing a level of visibility of the windscreen; and
generating a visibility score;
converting, dynamically, the windscreen into a display surface, in response to the visibility score falling below a predetermined threshold;
analyzing an external sensor feed of a vehicle to identify the visibility of a surrounding area;
initiating, dynamically, a generative adversarial network (GAN) enabled adaptation of the surrounding area of the vehicle, in real-time, to reconstruct a visual based on the external sensor feed; and
rendering, in real-time, the GAN enabled adaptation of the surrounding area of the vehicle on a transparent display layer of the windscreen of the vehicle.

9. The computer program product of claim 8, further comprising:
aligning the external sensor feed, of an identified viewing direction of a user, with the real-time rendering of the GAN enabled adaptation of the surrounding area on the transparent display layer of the windscreen.

10. The computer program product of claim 8, further comprising:
identifying a minimum amount of GAN enabled adaptation of the surrounding area data to render, on the transparent display layer of the windscreen, that is adequate to remove an identified visibility issue.

11. The computer program product of claim 10, wherein identifying a minimum amount of GAN enabled adaptation of the surrounding area data to render, on the transparent display layer of the windscreen, that is adequate to remove an identified visibility issue is based on:
data collected from one or more vehicles in a multi-vehicle ecosystem, and wherein the one or more vehicles collaborate with each other based on a relative position and direction of the one or more vehicles in the multi-vehicle ecosystem.

12. The computer program product of claim 8, wherein initiating the GAN enabled adaptation of the surrounding area of the vehicle, further comprises:
setting a maximum velocity limit of the vehicle to execute the GAN enabled adaptation to restore visibility to the user.

13. The computer program product of claim 8, further comprising:
comparing original images with a series of new synthetic images via a GAN discriminator;
determining a similarity threshold of the compared original images with the series of new synthetic images;
scoring the series of new synthetic images as highly representative if determined to be above a pre-defined threshold; and
processing the GAN enabled adaptation on the transparent display layer of the windshield.

14. The computer program product of claim 13, further comprising:
updating, continually, the series of new synthetic images at a highest frame rate supported by the GAN enabled adaptation;
projecting the series of new synthetic images onto the transparent display layer of the windshield.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
monitoring, via reference to one or more sensors, visibility of a windscreen, wherein monitoring the visibility comprises:
analyzing a level of visibility of the windscreen; and
generating a visibility score;
converting, dynamically, the windscreen into a display surface, in response to the visibility score falling below a predetermined threshold;
analyzing an external sensor feed of a vehicle to identify the visibility of a surrounding area;
initiating, dynamically, a generative adversarial network (GAN) enabled adaptation of the surrounding area of the vehicle, in real-time, to reconstruct a visual based on the external sensor feed; and
rendering, in real-time, the GAN enabled adaptation of the surrounding area of the vehicle on a transparent display layer of the windscreen of the vehicle.

16. The computer system of claim 15, further comprising:
aligning the external sensor feed, of an identified viewing direction of a user, with the real-time rendering of the GAN enabled adaptation of the surrounding area on the transparent display layer of the windscreen.

17. The computer system of claim 15, further comprising:
identifying a minimum amount of GAN enabled adaptation of the surrounding area data to render, on the transparent display layer of the windscreen, that is adequate to remove an identified visibility issue.

18. The computer system of claim 17, wherein identifying a minimum amount of GAN enabled adaptation of the surrounding area data to render, on the transparent display layer of the windscreen, that is adequate to remove an identified visibility issue is based on:
data collected from one or more vehicles in a multi-vehicle ecosystem, and wherein the one or more vehicles collaborate with each other based on a relative position and direction of the one or more vehicles in the multi-vehicle ecosystem.

19. The computer system of claim 15, wherein initiating the GAN enabled adaptation of the surrounding area of the vehicle, further comprises:
setting a maximum velocity limit of the vehicle to execute the GAN enabled adaptation to restore visibility to the user.

20. The computer system of claim 15, further comprising:
comparing original images with a series of new synthetic images via a GAN discriminator;
determining a similarity threshold of the compared original images with the series of new synthetic images;
scoring the series of new synthetic images as highly representative if determined to be above a pre-defined threshold; and
processing the GAN enabled adaptation on the transparent display layer of the windshield.
